(19) United States
(12) Patent Application Publication
(10) Pub. No.: US 2010/0251355 A1
(43) Pub. Date: Sep. 30, 2010

(54) METHOD FOR OBTAINING DATA FOR INTRUSION DETECTION

(75) Inventors: Yan LI, Tianjin (CN); Gui-Dong Liu, Tianjin (CN); Tom Chen, Taipei (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: INVENTEC CORPORATION, Taipei (TW)

(21) Appl. No.: 12/415,719

(22) Filed: Mar. 31, 2009

(51) Int. Cl. G06F 21/20; G06F 21/00

(52) U.S. Cl. 726/13; 726/22; 726/14

(57) ABSTRACT

A method for obtaining data for intrusion detection obtains data after forward chain filtering of a firewall. Modes of obtaining the data include a socket communication mode and a character device work mode. The method for obtaining the data for intrusion detection obtains the data filtered by the firewall, and reduces false alarms. Moreover, the method obtains the data after a network address translation (NAT) operation, so as to locate an attacker and a victim correctly. The method further obtains a decrypted Internet Protocol Security (IPsec) data packet, so as to process an IPsec data stream normally.

### BACKGROUND OF THE INVENTION

1. Field of Invention

The present invention relates to a method for processing data for network security, and more particularly to a method for obtaining data for intrusion detection.

2. Related Art

Intrusion detection is to perceive an intrusion. To perform the intrusion detection, information is collected at several key points in a computer network or a computer system and analyzed, so as to find whether behaviors violating security policies and signs of being attacked exist in the network or system. An intrusion detection system (IDS) is a combination of software and hardware for intrusion detection. Generally speaking, the IDS may be categorized as a host type and a network type. A host intrusion detection system usually uses system logs, application logs and the like as a data source. A network intrusion detection system (NIDS) uses data packets on a network as a data source.

FIG. 1 is a block diagram of the system function of obtaining data by an intrusion detection system 100 in the prior art, and FIG. 2 is a block diagram of the data stream of obtaining data by the intrusion detection system in the prior art. As shown in FIGS. 1 and 2, the intrusion detection system 100 in the prior art obtains data outside a firewall 200, and therefore the intrusion detection system 100 has the following defects.

(1) The traffic filtered by the firewall still appears in processing of the intrusion detection. An operation of data packet obtaining position on the left side in FIG. 2 is before a firewall operation. Thus, data packets discarded by the firewall will be obtained. These data packets are meaningless for the intrusion detection system, and may cause false alarms of the intrusion detection system.

(2) For the traffic for which a network address translation (NAT) function is enabled, the normal processing of the intrusion detection may not be realized. For a firewall in which an NAT operation is enabled, when data packets are forwarded, a source IP and a source port or a destination IP and a destination port must be changed correspondingly. The intrusion detection system needs to obtain these addresses and ports processed by the NAT operation to determine a correct attacker host and a correct victim host. These operations are accomplished in a “pre-routing destination network address translation (PRE_ROUTING DNAT)” module and a “post-routing source network address translation (POST_ROUTING SNAT)” module in FIG. 2. However, IP and port information of data packets obtained in the prior art is the information before the NAT operation; as a result, the intrusion detection system may locate a wrong attacker host or a wrong victim host.

(3) An encrypted Internet Protocol Security (IPsec) data packet may not be restored to a plain text for detection. The IPsec encrypted data packet will be resolved inside a protocol stack. The data packet obtaining position in the prior art is outside the protocol, so the obtained data packet is not decrypted, and the intrusion detection system cannot process the cipher text data packet.

### SUMMARY OF THE INVENTION

To solve problems or defects in the prior art, one of the objectives of the present invention is to provide a method for obtaining data for intrusion detection. The method comprises the following steps:

Registering a data obtaining point in a forward chain filtering module of a firewall; and

Obtaining the data for the intrusion detection at the data obtaining point after forward chain filtering.

Wherein, modes of obtaining the data include a socket communication mode and a character device work mode.

Compared with the prior art, the method for obtaining data for intrusion detection provided in the present invention may obtain data filtered by the firewall, and reduce false alarms. The method may also obtain data after an NAT operation, thereby locating an attacker and a victim correctly. The method may further obtain a decrypted IPsec data packet, thereby processing an IPsec data stream normally.

### BRIEF DESCRIPTION OF THE DRAWINGS

The present invention will become more fully understood from the detailed description given herein below for illustration only, and thus are not limitative of the present invention, and wherein:

FIG. 1 is a block diagram of the system function of obtaining data by an intrusion detection system in the prior art;

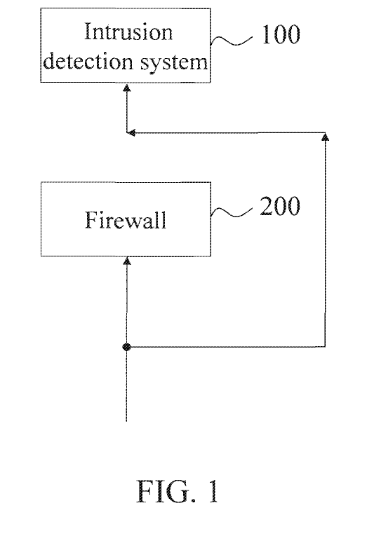

FIG. 2 is a block diagram of the data stream of obtaining the data by the intrusion detection system in the prior art;

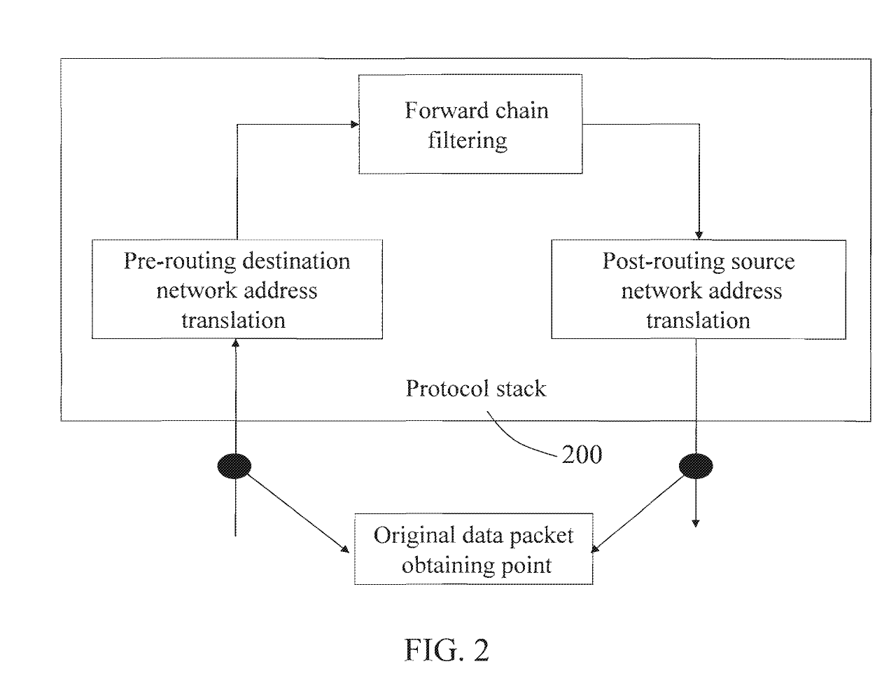

FIG. 3 is a block diagram of the system function of obtaining data by an intrusion detection system of the present invention;

FIG. 4 is a block diagram of the data stream of obtaining the data by the intrusion detection system of the present invention;

FIG. 5 is a flow chart of obtaining data in a socket communication mode of the present invention; and

FIG. 6 is a flow chart of obtaining data in a character device work mode of the present invention.

### DETAILED DESCRIPTION OF THE INVENTION

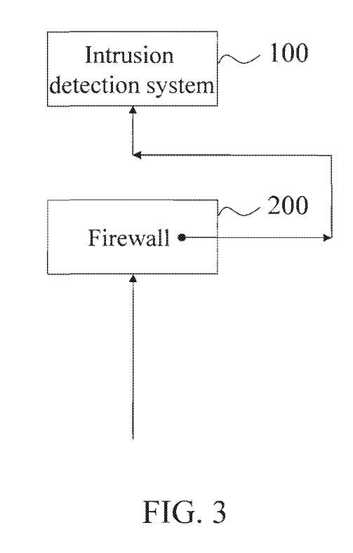

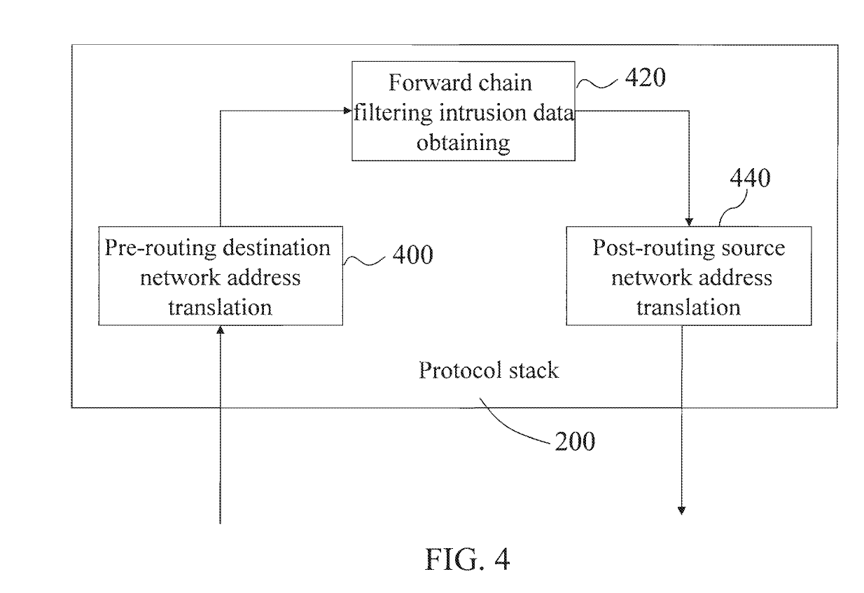

FIG. 3 is a block diagram of the system function of obtaining data by an intrusion detection system of the present invention, and FIG. 4 is a block diagram of the data stream of obtaining data by an intrusion detection system 100 of the present invention. As shown in FIG. 4, a firewall 200 comprises three main functional modules, that is, three function points, namely, pre-routing destination address translation (PRE_ROUTING DNAT) 400, forward chain filtering intrusion data obtaining (FORWARD) 420 and post-routing source network address translation (POST_ROUTING SNAT) 440. A data obtaining point of the present invention is located at “forward (FORWARD) chain filtering”, that is, the forward chain filtering intrusion data obtaining 420.

To simplify the illustration, the process of the protocol stack is divided into three function points: the pre-routing destination network address translation (PRE_ROUTING DNAT) 400, the forward chain filtering intrusion data obtaining (FORWARD) 420, and the post-routing source network address translation (POST_ROUTING SNAT) 440. Different operations are accomplished at the three points respectively. At the pre-routing destination network address translation 400, a DNAT operation of the data packet is accomplished, such that the data packet is restored to an internal network data packet. At the forward chain filtering intrusion data obtaining 420, first the filtering operation is accomplished, and then the data for intrusion detection is obtained, thereby ensuring that the filtered traffic does not appear in the processing of the intrusion detection. Meanwhile, as the DNAT operation is already accomplished at the pre-routing destination network address translation 400, intrusion detection processing may also be realized for a traffic for which an NAT function is enabled. In addition, in the processing of IPsec, all decrypted plain text data packets will flow through the forward chain filtering intrusion data obtaining 420. Thus, an encrypted IPsec data packet may also be restored to plain text for intrusion detection processing.

At the post-routing source network address translation 440, an SNAT operation of the data packet will be accomplished. This will change an original internal network data packet. However, as the original internal network data packet has already been captured at the forward chain filtering intrusion data obtaining 420 before, the changes here will not have any influence on the intrusion detection processing.

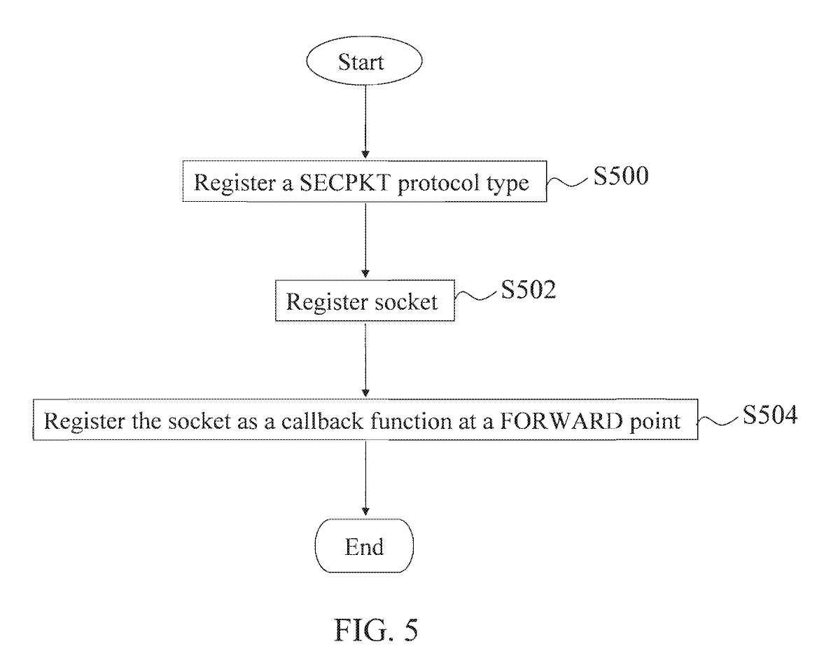

Then, a process of the method for obtaining data in a socket communication mode will be described with reference to FIG. 5. First, proto_register is called to register an SECPKT protocol type (Step S500). Next, sock_register is called to register the socket (Step S502). The sock_register has registered all processing functions that the SECPKT socket requires. These functions are corresponding to standard socket system calls of a user state. Additionally, the present invention also adopts a zero_copy mode to reduce the amount of data to be copied between the user state and a kernel state, and also to provide an mmap function. Next, the socket is registered as a callback function at the FORWARD point by calling nf_register_hook (Step S504), thereby determining a data obtaining position. nf_register_hook registers secpkt_hook for data obtaining. The obtained data is stored in a packet buffer ring.

The registering process of a socket module is described above. When the module is unloaded, all operations need to be performed in a reverse order.

After the steps are completed, a user state process may accomplish a data read operation through a standard socket system call. Corresponding functions, such as socket, close, poll, getsockopt, setsockopt, and mmap, are provided in the following.

The socket function is used to create a socket.

The close function is used to disable a socket.

The poll function is used to determine whether a data packet exists in the packet buffer ring, and perform reading if the data packet exists.

The getsockopt function is used to read data packet statistics information.

The setsockopt function is used to set a size of the packet buffer ring.

The mmap function accomplishes mapping of the packet buffer ring space. For the packet buffer ring, the kernel state and the user state determine a state of a slot in the packet buffer ring (that is, whether the data packets exists) according to a flag bit. Next, the kernel state and the user state maintain one index pointer respectively according to this flag bit, thereby accomplishing a read/write function of a producer-consumer as a whole.

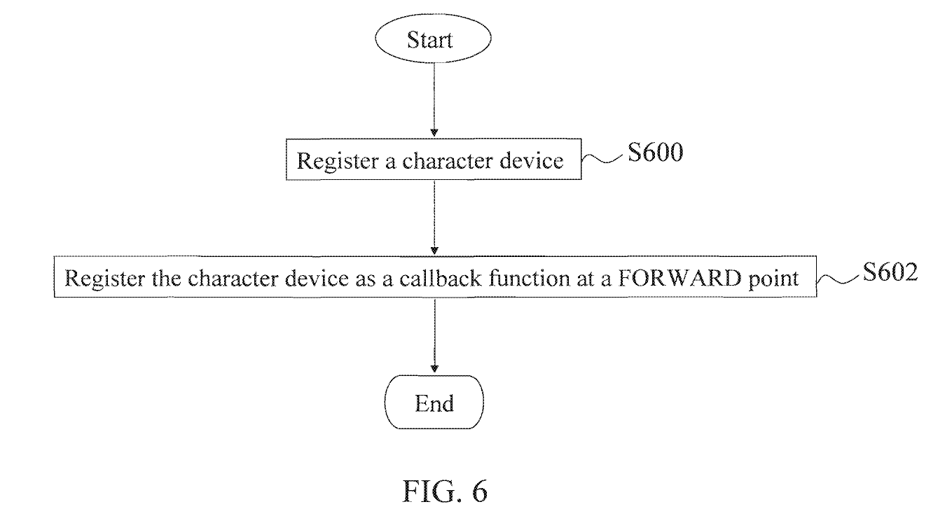

FIG. 6 is a flow chart of obtaining the data in a character device work mode of the present invention. As shown in FIG. 6, a character device is registered by calling register_chrdev (Step S600). The register_chrdev has registered all processing functions for operating this character device in the user state. These functions are corresponding to standard file operation system calls of the user state. Here, a zero_copy mode is also adopted to reduce the amount of data to be copied between the user state and the kernel state, and also to provide an mmap function. Next, the character device is registered as a callback function (Step S602) at the FORWARD point by calling nf_register_hook, thereby determining a data obtaining position. nf_register_hook registers secpkt_hook for data obtaining. The obtained data is stored in the packet buffer ring.

The process for registering a character device module is described above. When the module is unloaded, all the operations need to be performed in a reverse order.

After the steps are completed, the user state process may accomplish the data read operation through the standard file operation system call. Corresponding functions, such as open, close, poll, ioctl, and mmap, are provided in the following.

The open function is used to turn on the character device.

The close function is used to turn off the character device.

The poll function is used to determine whether a data packet exists in the packet buffer ring. If the data packet exists, read the data packet.

The ioctl function reads data packet statistics information and sets the size of the packet buffer ring through different command fields.

The mmap function accomplishes the mapping of the packet buffer ring. For the packet buffer ring, the kernel state and the user state determine the state of a slot in the packet buffer ring (that is, whether a data packet exists) according to a flag bit. Next, the kernel state and the user state maintain one index pointer respectively according to this flag bit, thereby accomplishing a read/write function for a producer-consumer as a whole.

What is claimed is:

1. A method for obtaining data for intrusion detection, for obtaining the data for the intrusion detection in an architecture comprising a firewall and an intrusion detection system, comprising:
registering a data obtaining point in a forward chain filtering module of the firewall; and
obtaining the data for the intrusion detection at the data obtaining point after forward chain filtering.

2. The method according to claim 1, wherein modes of obtaining the data comprise a socket communication mode and a character device work mode.

3. The method according to claim 2, wherein the socket communication mode further comprises:
registering a protocol type;
registering a socket; and
registering the socket as a callback function in a forward chain, thereby obtaining the data after the forward chain filtering.

4. The method according to claim 2, wherein the character device work mode further comprises:
registering a character device; and
registering the character device as a callback function in a forward chain, thereby obtaining the data after the forward chain filtering.

5. The method according to claim 3, wherein a zero_copy mode is adopted to reduce an amount of data to be copied between a user state and a kernel state, and to provide an mmap function.

6. The method according to claim 4, wherein a zero_copy mode is adopted to reduce an amount of data to be copied between a user state and a kernel state, and to provide an mmap function.
